(19) United States
(12) Patent Application Publication
(10) Pub. No.: US 2012/0142290 A1
(43) Pub. Date: Jun. 7, 2012

(54) APPARATUS AND METHOD FOR DETECTING EFFECTIVE RADIATED POWER

(75) Inventors: Seong-Min KIM, Daejeon (KR); Soon-Soo OH, Daejeon (KR); Young-Hwan LEE, Daejeon (KR)

(73) Assignee: Electronics and Telecommunications Research Institute of Daejeon

(21) Appl. No.: 13/010,842

(22) Filed: Jan. 21, 2011

(30) Foreign Application Priority Data
Dec. 1, 2010 (KR) 10-2010-0121341

(51) Int. Cl. H04B 17/00

(52) U.S. Cl. 455/115.1

(57) ABSTRACT

Provided is an apparatus and method for measuring effective radiated power. The apparatus includes a reference signal power measuring unit configured to measure power of a reference signal from a wireless signal transmitted from a wireless device, and an effective radiated power calculating unit configured to calculate effective radiated power according to an allocation ratio of a reference signal in an entire signal domain using the measured reference signal power from the reference signal power measuring unit.

### CROSS-REFERENCE(S) TO RELATED APPLICATIONS

The present application claims priority of Korean Patent Application No. 10-2010-0121341, filed on Dec. 1, 2010, which is incorporated herein by reference in its entirety.

### BACKGROUND OF THE INVENTION

1. Field of the Invention

Exemplary embodiments of the present invention relate to an apparatus and method of measuring effective radiated power; and, more particularly, to an apparatus and method of measuring effective radiated power for shortening a measurement duration of measuring the effective radiated power and improving accuracy of measuring the effective radiated power by measuring power of a reference signal of a wireless signal transmitted from a wireless device and calculating the effective radiated power based on the measured power and an allocation ratio of a reference signal in entire signal domain.

2. Description of Related Art

In general, effective radiated power (ERP) is one of parameters for measuring performance of a wireless device such as a mobile communication base station, a repeater, a wireless local area network (WLAN) access point. Particularly, the effective radiated power (ERT) is a performance index indicating the maximum transmission power of a wireless device. The effective radiated power (ERP) has been calculated by multiplying a transmission power of a wireless device antenna with a predetermined gain. That is, the effective radiated power (ERP) means electric power radiated uniformly in all directions from a wireless device.

In generally, the effective radiated power (ERP) of a wireless device has been measured by theoretically calculating a maximum transmission power and an antenna gain. In order to measure the effective radiated power (ERP), it was required to set up the wireless device in a test mode or to set up the wireless device to repeatedly transmit a predetermined patterned signal such as a sin wave signal. Then, a related detector receives a signal transmitted from the wireless device through a receiving antenna and measures the power of the received signal. As the detector, a spectrum analyzer or a power detector has been used.

Further, the effective radiated power (ERP) of a wireless device was measured after installing the wireless device in an anechoic chamber or an outdoor test site. Here, the wireless device is connected to an antenna and set up to repeatedly transmit a predetermined patterned signal.

As described above, the maximum transmission power is measured after a wireless device is set up in a test mode or set up to repeatedly transmit a predetermined patterned signal. Then, the effective radiated power (ERP) of the wireless device is calculated based on the maximum transmission power. Alternately, the effective radiated power (ERP) is measured after the wireless device is moved to a predetermined test site in a predetermined measurement environment. That is, it was required to perform the above described pre-process for measuring the effective radiated power (ERP) such as setting up a wireless device or providing a predetermined measurement environment in order to measure the effective radiated power (ERP) of the wireless device.

Particularly, it was essentially required to change an operation mode of a wireless device or to set up a wireless device to repeatedly transmit a predetermined patterned signal to accurately measure the effective radiated power (ERP) of a wireless device in use. Accordingly, it was required to stop communication during measuring the effective radiated power (ERP). It means that the communication has to be interrupted for measuring the effective radiated power.

Since a transmission power of a signal transmitted from a wireless device is changed according to the number of mobile devices accessing the wireless device, it is difficult to accurately measure the transmission power changing in a time domain when the transmission power thereof is measured without changing an operation mode. Furthermore, it is also difficult to accurately measure the effective radiated power because it requires such long measurement duration. For example, a simple power detector or a spectrum analyzer has been used to measure the effective radiated power (ERP). Accordingly, it is very difficult to accurately measure overall effective radiated power changing in a time domain and a frequency domain using such a simple power detector or spectrum analyzer. Moreover, the ERP was statistically estimated based on numerous measurement results obtained through long measurement durations in order to accurately measure the ERP. Accordingly, there is limitation to accurately measure effective radiated power because of such long measurement duration.

### SUMMARY OF THE INVENTION

An embodiment of the present invention is directed to an apparatus and method of measuring effective radiated power for shortening a measurement duration of measuring the effective radiated power and improving accuracy of measuring the effective radiated power by measuring power of a reference signal of a wireless signal transmitted from a wireless device and calculating the effective radiated power based on the measured power and an allocation ratio of a reference signal in entire signal domain.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for measuring effective radiated power includes: a reference signal power measuring unit configured to measure power of a reference signal from a wireless signal transmitted from a wireless device; and an effective radiated power calculating unit configured to calculate effective radiated power according to an allocation ratio of a reference signal in an entire signal domain using the measured reference signal power from the reference signal power measuring unit.

The apparatus may further include an antenna controller configured to control a height and an angle of a receiving antenna for receiving a wireless signal from the wireless device.

The reference signal power measuring unit may include: a Radio Frequency (RF) receiver configured to convert the received wireless signal to a baseband analog signal through frequency conversion; an analog-to-digital (A/D) converter configured to convert the baseband analog signal from the RF receiving unit to a digital signal; a synchronizer configured to obtain a demodulation time and frequency synchronization of the digital signal from the A/D converter; and a reference signal power measuring unit configured to measure reference signal power by demodulating the digital signal according to the obtained demodulation time and the frequency synchronization.

The reference signal power measuring unit may transfers wireless signal information including a type of a wireless signal and a frame structure to the effective radiated power calculator. The effective radiated power calculator may calculate an allocation ratio of a reference signal in an entire signal domain using the transferred wireless signal information and calculates the effective radiated power based on the allocation ratio.

The reference signal may be a preamble signal or a pilot signal.

In accordance with another embodiment of the present invention, a method for measuring effective radiated power, includes: measuring reference signal power from a wireless signal transmitted from a wireless device; and calculating effective radiate power according to an allocation ratio of a reference signal in an entire signal domain using the measured reference signal power.

The method may further include: before said measuring reference signal power, controlling a height and an angle of a receiving antenna for receiving a wireless signal from the wireless device.

In said calculating effective radiate power, the allocation ratio of the reference signal may be calculated using wireless signal information including a type of a wireless signal received from the wireless device and a frame structure thereof and the effective radiated power may be calculated based on the calculated allocation ratio.

### BRIEF DESCRIPTION OF THE DRAWINGS

FIG. 1 is a diagram illustrating an apparatus of measuring effective radiated power (ERP) in accordance with an embodiment of the present invention.

FIG. 2 is a diagram illustrating a reference signal power measuring unit of FIG. 1.

FIG. 3A is a diagram illustrating a downlink frame structure of a WiBro signal.

FIG. 3B is a diagram illustrating a downlink frame structure of a LTE signal.

FIG. 4 is a flowchart illustrating a method of measuring effective radiated power (ERP) in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

When a first part is referred to as being “connected” to a second part, it could means that the first part is directly connected to the second part, or it could also means that the first part and the second part are “electrically connected” having a third element in-between throughout the specification. Furthermore, when a part is referred to as “including” a constituent element, it does not means that the part excludes other constituent elements, but it means that the part can further include other constituent elements, unless otherwise specified.

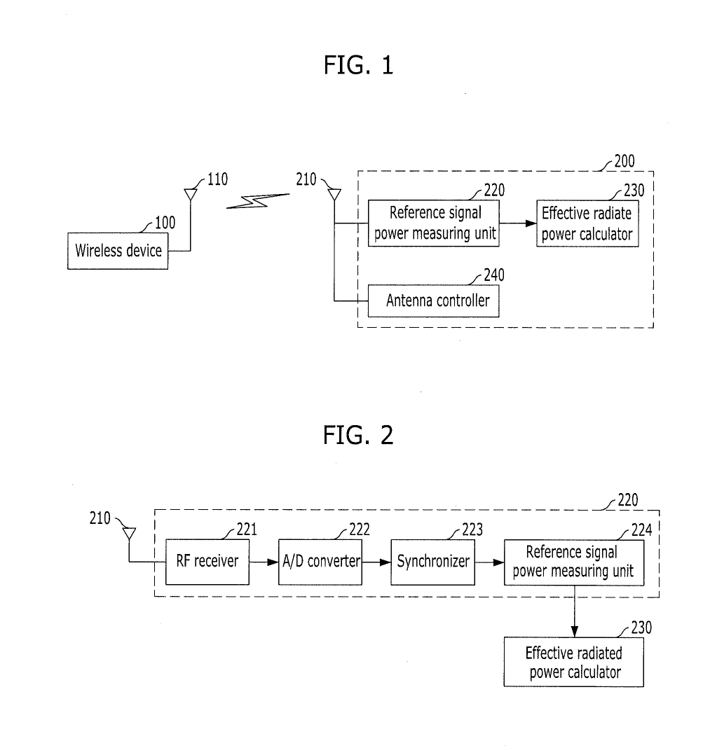

FIG. 1 is a diagram illustrating an apparatus of measuring effective radiated power (ERP) in accordance with an embodiment of the present invention.

Referring to FIG. 1, the apparatus 200 of measuring effective radiated power (ERP) in accordance with an embodiment of the present invention measures effective radiated power (ERP) using a reference signal which is essentially inserted for using a digital communication scheme such as a cellular scheme, a PCS scheme, an IMT-2000 scheme, and a WLAN scheme.

In other words, the apparatus 200 detects a reference signal of a wireless signal radiated from a target wireless device 100 and measures power of the detected reference signal. Then, the apparatus 200 calculates a current transmission power and a maximum transmission power of a transmission signal using a power ratio of the measured reference signal and a real data signal.

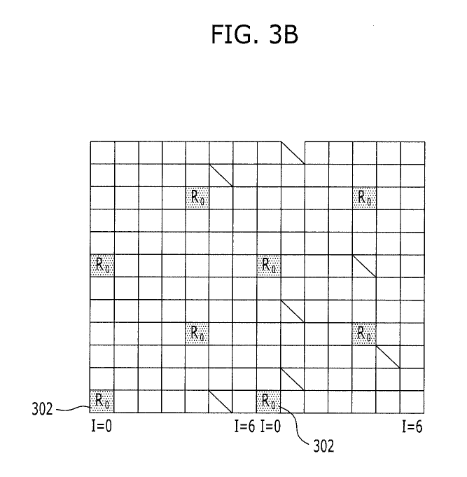

The reference signals are allocated in entire signal domain with an accurate allocation ratio and transmitted from at an accurate location. It will be described in more detail with reference to FIGS. 3A and 3B. Accordingly, the apparatus 200 in accordance with an embodiment of the present invention calculates the allocation ratio of the reference signal in entire signal domain and uses the calculated allocation ratio to calculate the effective radiated power of the wireless device 100. Since it is not required to statistically and repeatedly measure the power changed in a time domain and a frequency domain for long measurement duration, the measurement duration can be shortened and the effective radiated power can be accurately measured.

In more detail, the apparatus 200 in accordance with an embodiment of the present invention includes a receiving antenna 210 for receiving a wireless signal radiated from the wireless device 100 through a transmission antenna 100, a reference signal power measuring unit 220 for measuring power of a reference signal by demodulating the received wireless signal through the receiving antenna 210, an effective radiated power calculator 230 for calculating effective radiated power of the wireless device 100 using the measured reference signal power from the reference signal power measuring unit 220, and an antenna controller 240 for controlling a position and a direction of the receiving antenna 210.

The receiving antenna 210 receives a wireless signal radiated from the transmission antenna 110 of the wireless device 100 and transfers the received wireless signal to the reference signal power measuring unit 220.

The reference signal power measuring unit 220 obtains synchronization by demodulating the wireless signal transferred through the receiving antenna 210, measures power of a reference signal such as a pilot signal or a preamble signal, and transfers the measured reference signal power to the effective radiated power calculator 230. The reference signal power measuring unit 220 also transfers wireless signal information including a type of a wireless signal and a frame structure thereof to the effective radiated power calculator 230.

The effective radiated power calculator 230 calculates effective radiated power of the wireless device 100 using the wireless signal information and the reference signal power from the reference signal power measuring unit 220. Here, the effective radiated power calculator 230 calculates an allocation ratio of a reference signal in entire signal domain using the wireless signal information and calculates the current power and the effective radiated power of the wireless device 100.

The antenna controller 240 controls a height and an angle of the receiving antenna 210.

The effective radiated power calculator 230 and the antenna controller 240 may be mounted or connected to a computer (not shown) for providing a user interface and are controlled to perform a series of operations for measuring effective radiated power.

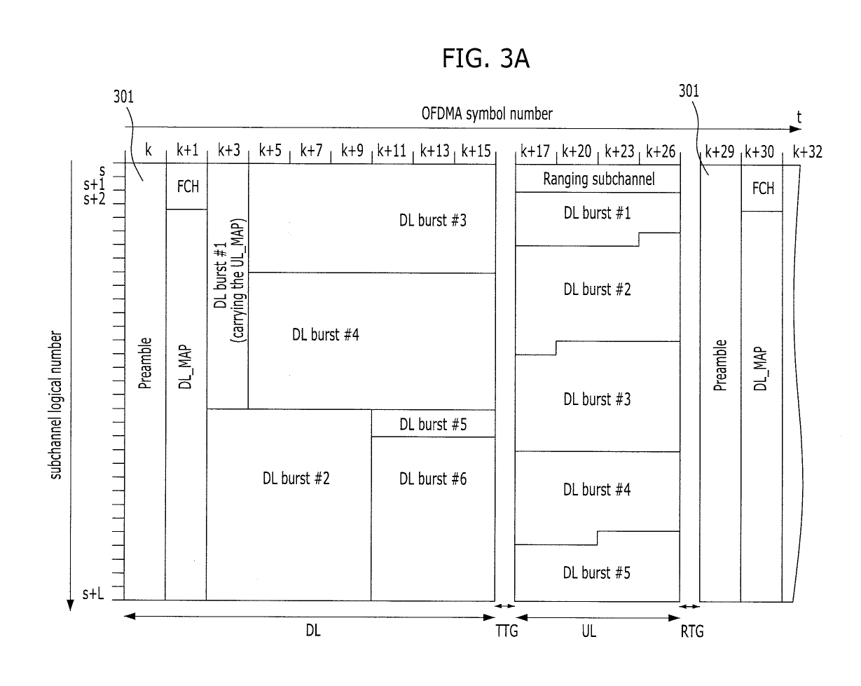

FIG. 2 is a diagram illustrating a reference signal power measuring unit of FIG. 1.

As shown in FIG. 2, the reference signal power measuring unit 220 includes a Radio Frequency (RF) receiver 221, an Analog to Digital (A/D) converter 222, a synchronizer 223, and a reference signal power measuring unit 224.

The RF receiver 221 receives the wireless signal from the receiving antenna 210, converts the received wireless signal to the baseband signal, and transfers the baseband signal to the A/D converter 222.

The A/D converter 222 converts the baseband analog signal from the RF receiver 221 to a digital signal and transfer the corresponding digital signal to the synchronizer 223.

The synchronizer 223 obtains demodulation time and frequency synchronization for the digital signal from the A/D converter 222.

The reference signal power measuring unit 224 demodulates the digital signal according to the obtained corresponding demodulation time and frequency synchronization and measures the reference signal power based on the demodulation result. Here, the reference signal power measuring unit 224 transfers the reference signal power and wireless signal information to the effective radiated power calculator 230.

FIG. 3A is a diagram illustrating a structure of a downlink frame of a Wireless Broadband (WiBro) signal, and FIG. 3B is a diagram illustrating a structure of downlink frame of a Long Term Evolution (LTE) signal. Here, in the diagram of FIGS. 3A and 3B, a horizontal axis denotes a time and a vertical axis denotes a frequency.

Referring to FIG. 3A, the downlink frame of the WiBro signal starts with a preamble signal 301. Here, the WiBro signal is an IEEE 802.16e signal using an OFDM scheme. The preamble signal 301 is a reference signal for obtaining synchronization. Such a preamble signal 301 is accurately allocated in a frequency domain and a time domain of an entire signal domain. It means that the preamble signal 301 occupies predetermined regions of a time domain and a frequency domain with a constant ratio in the downlink signal. On the contrary, a burst signal has a variable signal region according to a status of users, for example, the number of users accessing to the wireless device 100 because the burst signal is a real data region transmitted from the wireless device 100.

Referring to FIG. 3B, a predetermined time and a predetermined frequency are identified as one unit signal in the LTE signal. In the downlink frame structure of the LTE signal, data is transmitted by combining such unit signals. In the LTE signal, it is required to insert a pilot signal 302 in a predetermined region. That is, such a pilot signal 302 is allocated in the entire signal domain with a predetermined allocation ratio.

As described above, the wireless device 100 must transmit the reference signal such as the preamble signal or the pilot signal with the predetermined ratio in the entire signal domain. Accordingly, the apparatus 200 in accordance with an embodiment of the present invention can accurately measure the effective radiated power in a comparative short measurement duration using the reference signal. That is, the apparatus 200 in accordance with an embodiment of the present invention can accurately calculate the effective radiate power through one measurement without repeatedly performing measurement operations for statistical estimation of a signal varying according to frequencies and time.

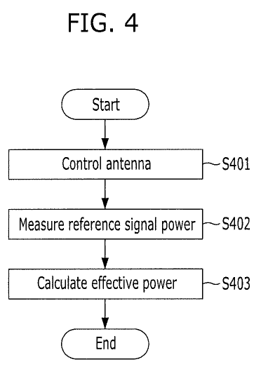

FIG. 4 is a flowchart illustrating a method for measuring effective radiated power (ERP) in accordance with an embodiment of the present invention.

At step S401, the antenna controller 240 controls a position and a direction of a receiving antenna 210 to measure effective radiated power (ERP) of a wireless device 100.

At step S402, the reference signal power measuring unit 220 measures reference signal power (ERP) from a wireless signal transferred from the wireless device 100 through the receiving antenna 210. Here, the reference signal power measuring unit 220 transfers the reference signal power and the wireless signal information to the effective radiated power calculator 230.

At step S403, the effective radiated power calculator 230 calculates effective radiated power according to an allocation ratio of a reference sign in an entire signal domain using the reference signal power. Here, the effective radiated power calculator 230 calculates an allocation ratio of a reference signal in an entire signal domain using the wireless signal information.

As described above, in the apparatus and method for measuring effective radiated power in accordance with an embodiment of the present invention, power of a reference signal such as a preamble signal or a pilot signal is calculated from a wireless signal transmitted from a wireless device, and effective radiated power is calculated based on the calculated reference signal power and an allocation ratio of the reference signal in an entire signal domain. Accordingly, the measurement duration of the effective radiated power is shortened and the accuracy thereof is improved.

Further, in an embodiment of the present invention, the effective radiated power can be measured without requiring long measurement duration by using a reference signal which is not changed although the number of users accessing a wireless device is changed.

Moreover, the apparatus and method of measuring effective radiated power according to an embodiment of the present invention is a proper method for measuring power varying according to a time and a frequency because it measures simple power. Further, the apparatus and method of measuring effective radiated power in accordance with an embodiment of the present invention shortens measurement duration for a wireless device in operation without statistical estimation and improves the accuracy thereof.

The embodiments of the present invention described above can be realized as a program and stored in a computer-readable recording medium such as CD-ROM, RAM, ROM, floppy disks, hard disks, magneto-optical disks and the like. Since the process can be easily implemented by those skilled in the art to which the present invention pertains, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. An apparatus for measuring effective radiated power, comprising:
a reference signal power measuring unit configured to measure power of a reference signal from a wireless signal transmitted from a wireless device; and
an effective radiated power calculating unit configured to calculate effective radiated power according to an allocation ratio of a reference signal in an entire signal domain using the measured reference signal power from the reference signal power measuring unit.

2. The apparatus of claim 1, further comprising:
an antenna controller configured to control a height and an angle of a receiving antenna for receiving a wireless signal from the wireless device.

3. The apparatus of claim 1, wherein the reference signal power measuring unit comprises:
a Radio Frequency (RF) receiver configured to convert the received wireless signal to a baseband analog signal through frequency conversion;
an analog-to-digital (A/D) converter configured to convert the baseband analog signal from the RF receiving unit to a digital signal;
a synchronizer configured to obtain a demodulation time and frequency synchronization of the digital signal from the A/D converter; and
a reference signal power measuring unit configured to measure reference signal power by demodulating the digital signal according to the obtained demodulation time and the frequency synchronization.

4. The apparatus of claim 1, wherein the reference signal power measuring unit transfers wireless signal information including a type of a wireless signal and frame structure to the effective radiated power calculator, and
wherein the effective radiated power calculator calculates an allocation ratio of a reference signal in an entire signal domain using the transferred wireless signal information and calculates the effective radiated power based on the allocation ratio.

5. The apparatus of claim 1, wherein the reference signal is a preamble signal or a pilot signal.

6. A method for measuring effective radiated power, comprising:
measuring reference signal power from a wireless signal transmitted from a wireless device; and
calculating effective radiate power according to an allocation ratio of a reference signal in an entire signal domain using the measured reference signal power.

7. The method of claim 6, further comprising:
before said measuring reference signal power, controlling a height and an angle of a receiving antenna for receiving a wireless signal from the wireless device.

8. The method of claim 6, wherein in said calculating effective radiate power,
the allocation ratio of the reference signal is calculated using wireless signal information including a type of a wireless signal received from the wireless device and a frame structure thereof and the effective radiated power is calculated based on the calculated allocation ratio.

9. The method of claim 8, wherein the reference signal comprises a preamble signal or a pilot signal.
